(19) United States
(12) Patent Application Publication
(10) Pub. No.: US 2008/0209958 A1
(43) Pub. Date: Sep. 4, 2008

(54) SAFETY LOCK FOR REAL ESTATE SIGNS

(76) Inventor: ROBERT J. VISOTCKY, Carlsbad, CA (US)

Correspondence Address: CATALYST LAW GROUP, APC, 9710 SCRANTON ROAD, SUITE S-170, SAN DIEGO, CA, 92121, US

(21) Appl. No.: 12/039,902

(22) Filed: Feb. 29, 2008

Related U.S. Application Data
(60) Provisional application No. 60/892,484, filed on Mar. 1, 2007.

(51) Int. Cl. E05B 65/00; G09F 7/00

(52) U.S. Cl. 70/57; 40/584

(57) ABSTRACT

The present invention is generally directed to the field of safety locks for display devices. In particular, the present invention is directed to a safety lock for real estate listing signs.

### CROSS-REFERENCES

This application claims priority from Provisional Application Ser. No. 60/892,484 by Robert J. Visotcky, entitled “Safety Lock for Real Estate Signs,” filed Mar. 1, 2007, which is incorporated herein in its entirety by this reference.

### FIELD OF THE INVENTION

The present invention is generally directed to the field of safety locks for display devices. In particular, the present invention is directed to a safety lock for real estate listing signs.

### BACKGROUND OF THE INVENTION

Display devices are commonly used to facilitate the selling and renting of real estate. For example, real estate professionals commonly use signs located at visible spots adjacent to an available property to advertise the property to the public. A typical display device design used in the real estate industry comprises a vertical post with a horizontal cross-arm to hang an advertising panel. The advertising panel is typically hung on the horizontal cross-arm by various hanging means, such as rope, rings, or light chains.

There are a number of drawbacks associated with conventional real estate listing signs. One drawback is that such real estate signs are difficult to view after dark. One solution is to employ a lighting system to illuminate the real estate sign. For example, LISTINGLIGHT™ real estate sign light (available from Listing Light, LLC, Carlsbad, Calif.) offers a light source that may be attached to the real estate sign in order to illuminate it after dark. However, there remains a need to protect the real estate sign and the attached lighting system from theft. It is known in the art that real estate signs are frequently stolen and vandalized. Yet another drawback is that the advertising panels are routinely loosely attached to the horizontal cross-arm of a real estate sign. In windy conditions, such loosely attached advertising panels may be torn off the cross-arm, destroying the sign.

Therefore, there is an unmet need in the art for a display device safety lock capable of preventing theft of the display device and any attachments thereto, and also capable of stabilizing the display device in windy conditions.

### SUMMARY OF THE INVENTION

In one aspect, the present invention relates to a safety lock for display devices. In the preferred embodiment, the safety lock comprises a top faceplate, a bottom faceplate, and a locking rod. Preferably, the locking rod is contained between the top faceplate and the bottom faceplate so that only top and bottom loops of the locking rod protrude outside of the faceplates. The top loop of the locking rod may be used to connect to the horizontal cross-arm of a display device and the bottom loop of the locking rod may be used to connect to the advertising panel of a display device. The top faceplate and the bottom faceplate may be removably and securely attached together with the locking rod between them to secure the advertising panel to the horizontal cross-arm of a display device. Preferably, the top faceplate and the bottom faceplate are securely attached together with the locking rod between them, so that one may not detach them and open the safety lock without a key. In one alternative, the top faceplate and the bottom faceplate are securely attached together by means of an unconventional, tamper-resistant screw, wherein the screw may be driven only by means of a special corresponding screwdriver. In such embodiment, the screw serves as a lock and the corresponding screwdriver serves as a key. Other means to removably and securely attach the top and bottom faceplates together will be known to one of ordinary skill in the art and are within the scope of the present invention.

### BRIEF DESCRIPTION OF THE DRAWINGS

FIG. 1 demonstrates an exploded view of the preferred embodiment of a safety lock of the present invention.

FIG. 2 demonstrates a view of the preferred embodiment of a safety lock of the present invention in a closed position.

FIG. 3 demonstrates a view of the preferred embodiment of a screw of the present invention.

FIG. 4 demonstrates a view of the preferred embodiment of a key of the present invention.

FIG. 5 demonstrates a view of two safety locks attached to a display device.

### DETAILED DESCRIPTION OF THE INVENTION

In the following detailed description, reference is made to the accompanying drawings, which form a part hereof, and in which is shown by way of illustration specific embodiments in which the invention can be practiced. These embodiments are described in sufficient detail to enable those of ordinary skill in the art to practice the invention. It is understood by these same artisans that other embodiments can be utilized and that structural changes can be made without departing from the spirit and scope of the current invention. Thus, the following detailed description is not meant to limit the breadth of the invention, which is defined by the appended claims.

### NUMBERING REFERENCE LIST

10. Safety Lock
12. Top Faceplate
22. Threaded Boss
14. Bottom Faceplate
24. Orifice
16. Locking Rod
18. Top Stop
20. Bottom Stop
30. Screw
32. Head
40. Screwdriver
42. Driver
50. Cross-Arm
52. Advertising Panel

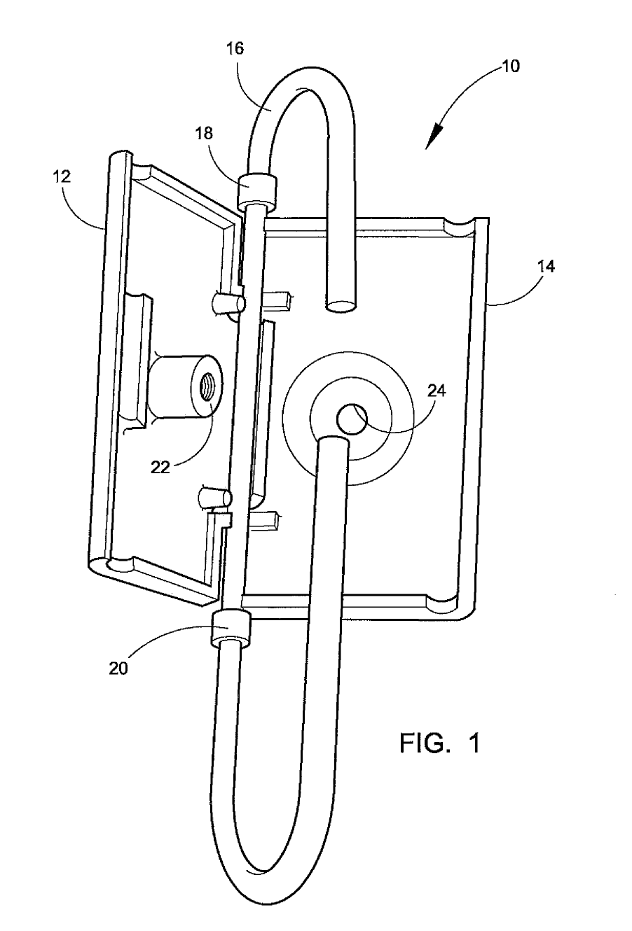

FIG. 1 provides an exploded view of the preferred embodiment of a safety lock of the present invention. The safety lock 10 comprises a top faceplate 12, a bottom faceplate 14, and a locking rod 16. In one alternative, the top faceplate 12 further comprises a threaded boss 22, the bottom faceplate 14 further comprises an orifice 24, and the locking rod 16 further comprises a top stop 18 and a bottom stop 20. In the preferred embodiment, the locking rod 16 is placed between the top faceplate 12 and the bottom faceplate 14.

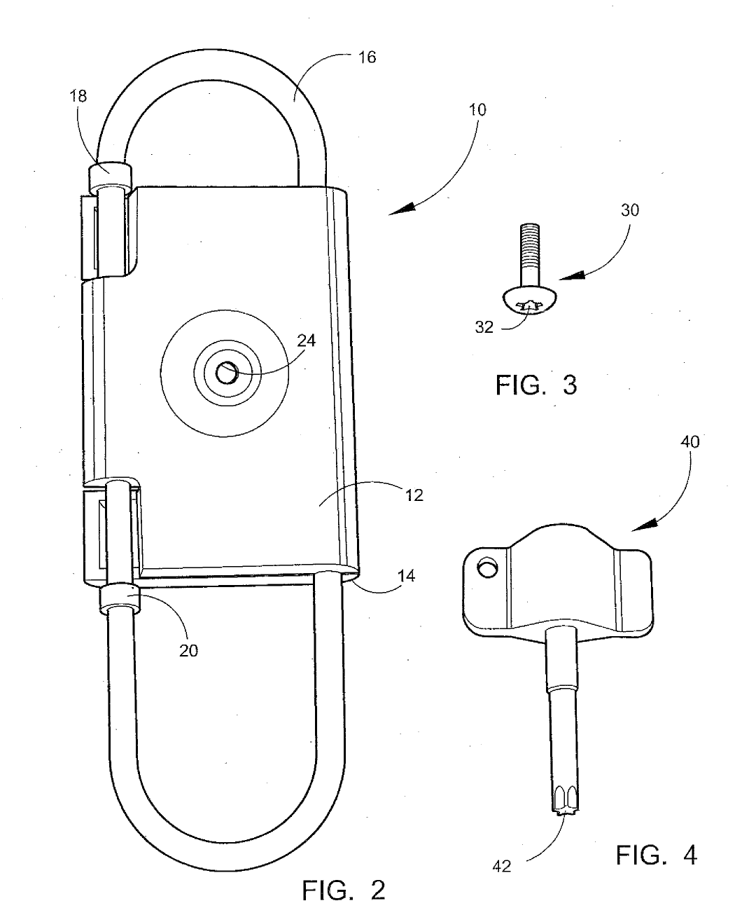

FIG. 2 provides a view of the preferred embodiment of a safety lock of the present invention in a closed position. In one alternative, the locking rod 16 is placed between the top faceplate 12 and the bottom faceplate 14 and the faceplates are removably and securely attached together. For example, the faceplates may be attached together by a screw. Preferably, the screw comprises an unconventional head, such that said screw may only be driven by a corresponding unconventional screwdriver.

FIG. 3 provides a view of the preferred embodiment of an unconventional screw of the present invention. The screw 30 comprises an unconventional head 32. The unique pattern of the unconventional head 32 serves as a security mechanism designed to prevent tampering with the safety lock once it is closed. Preferably, once the locking rod 16 is placed between the top faceplate 12 and the bottom faceplate 14, the faceplates are brought together and removably and securely attached with a screw 30. Preferably, the screw 30 is inserted through the threaded boss 22 on the top faceplate 12 and the orifice 24 on the bottom faceplate. The screw 30 may then be tightened to hold the faceplates together. In one alternative, the unconventional screw 30 may be tightened with an unconventional screwdriver 40. In the preferred embodiment, the unconventional screw serves as a lock and the unconventional screwdriver serves as a key.

FIG. 4 provides a view of the preferred embodiment of an unconventional screwdriver of the present invention. The screwdriver 40 comprises an unconventional driver 42. Preferably, said unconventional driver 42 corresponds to the unconventional head 32 of the screw 30.

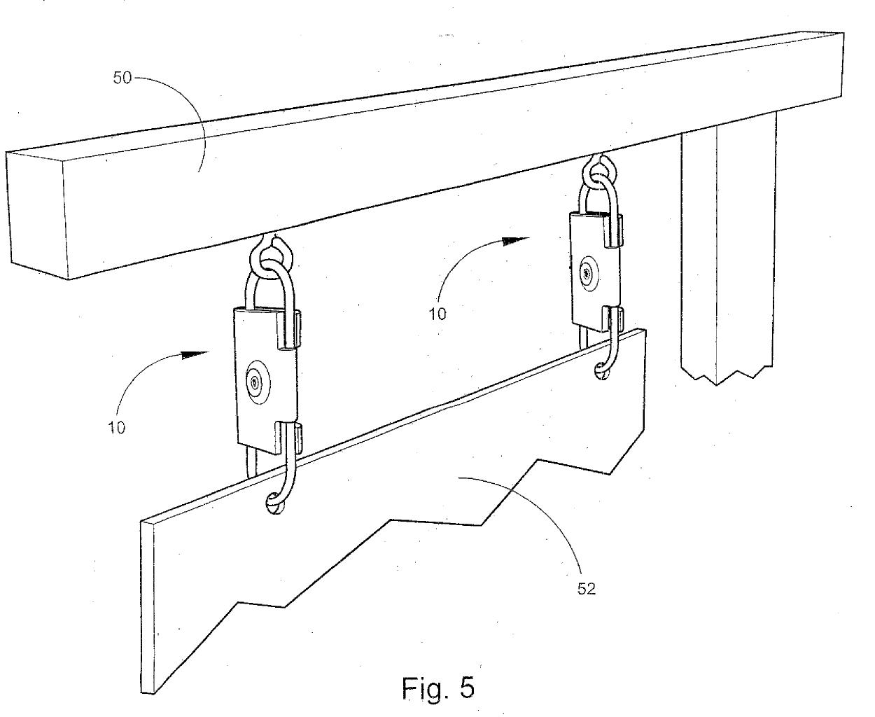

FIG. 5 provides a view of two safety locks of the present invention attached to a display device. In the preferred embodiment, the top loop of the locking rod 16 is attached to the cross-arm 50 of the display device, and the bottom loop of the locking rod 16 is attached to the advertising panel 52 of the display device. The top stop 18 and the bottom stop 20 located on the locking rod 16 (not shown in FIG. 5) prevent the locking rod 16 from slipping under the weight of the advertising panel 52. While two safety locks are demonstrated in FIG. 5, any number of safety locks may be used to secure a specific display device.

In one embodiment, the present invention relates to a safety lock for display devices. In the preferred embodiment, the safety lock comprises a top faceplate, a bottom faceplate, and a locking rod. Preferably, the locking rod is shaped so as to form a top loop and a bottom loop. The loops may be open or closed. Preferably, the top loop and the bottom loop are open loops. The locking rod may also contain stops to prevent the rod from slipping once secured in place between the top faceplate and the bottom faceplate. In the preferred embodiment, the locking rod is placed between the top faceplate and the bottom faceplate so that only top and bottom loops of the locking rod protrude outside of the faceplates. The top loop of the locking rood may be used to connect to the horizontal cross-arm of a display device and the bottom loop of the locking rod may be used to connect to the advertising panel of a display device.

In the preferred embodiment, the top faceplate and the bottom faceplate may be removably attached together with the locking rod between them to secure the advertising panel to the horizontal cross-arm of a display device. Preferably, the top faceplate and the bottom faceplate are securely attached together with the locking rod between them, so that one may not detach them and open the safety lock without a key. The top faceplate and the bottom faceplate may be removably and securely attached together by a variety of attachment means. Such attachment means may include, but are not limited to, combination locks, nuts, bolts, screws, and electronic locks. In one alternative, the top faceplate and the bottom faceplate are securely attached together by means of an unconventional, tamper-resistant screw, wherein the screw may be driven only by means of a special corresponding screwdriver. For example, the head of the unconventional screw is designed such that the screw may only be driven by a corresponding, unconventional screwdriver. Incorporation of an unconventional screw provides further deterrent to thieves, since they will not be able to open the safety lock and remove the display device unless they possess a corresponding unconventional screwdriver. In such embodiment, the screw serves as a lock and the corresponding screwdriver serves as a unique key. Other means to removably and securely attach the top and bottom faceplates together will be known to one of ordinary skill in the art and are within the scope of the present invention.

### EXAMPLE 1

The following example is provided to illustrate the preferred embodiment of the present invention. A safety lock is opened by a corresponding unconventional screwdriver to unscrew an unconventional screw. The screw is removed from the orifice on the bottom faceplate and the threaded boss on the top faceplate. Once the screw is removed, the faceplates are pulled apart to expose the locking rod. While the safety lock is in the open position, the top loop of the locking rod is attached to a horizontal cross-arm of the display device and the bottom loop of the locking rod is attached to an advertising panel of the display device. The top faceplate and the bottom faceplate are then closed and secured with an unconventional screw. The unconventional screw is inserted through the threaded boss on the top faceplate and the orifice on the bottom faceplate. The screw is then tightened with the corresponding unconventional screwdriver to secure the safety lock to the display device.

It is to be understood that the above description is intended to be illustrative, and not restrictive. Many other embodiments within the scope of the present invention will be accessible to those of skill in the art upon reviewing the above description. The scope of the present invention should, therefore, be determined with reference to the appended claims, along with the full scope of equivalents to which such claims are entitled.

I claim:

1. A safety lock for display devices comprising a locking rod placed between a top faceplate and a bottom faceplate, wherein said locking rod further comprises a top loop and a bottom loop.

2. The safety lock of claim 1, wherein the locking rod is contained between the top faceplate and the bottom faceplate so that only the top and the bottom loops of the locking rod protrude outside of the faceplates.

3. The safety lock of claim 1, wherein the top loop of the locking rod is used to connect to the horizontal cross-arm of a display device.

4. The safety lock of claim 1, wherein the bottom loop of the locking rod is used to connect to the advertising panel of a display device.

5. The safety lock of claim 1, wherein the top faceplate and the bottom faceplate are removably and securely attached together with the locking rod between them to secure an advertising panel to the horizontal cross-arm of a display device.

6. The safety lock of claim 5, wherein the top faceplate and the bottom faceplate are securely attached together with the locking rod between them, so that the top faceplate and the bottom faceplate are not detachable and the safety lock cannot be opened without use of a key.

7. The safety lock of claim 6 wherein the top faceplate and the bottom faceplate are securely attached together by means of a tamper-resistant screw drivable only by a corresponding screwdriver serving as a key.

8. The safety lock of claim 1 wherein the top loop and the bottom loop are open loops.

9. The safety lock of claim 1 wherein the top faceplate and the bottom faceplate are removably and securely attached by an attachment means selected from the group consisting of combination locks, nuts, bolts, screws, and electronic locks.

10. An assembly comprising:
(a) at least one safety lock of claim 1; and
(b) a display device to which the at least one safety locks is attached.

11. The assembly of claim 10 comprising two safety locks.
